(19) United States
(12) Patent Application Publication
(10) Pub. No.: US 2018/0307646 A1
(43) Pub. Date: Oct. 25, 2018

(54) DISTRIBUTION MODULE WITH SELECTOR SWITCH

(71) Applicant: Belden Deutschland GmbH, Schalksmühle (DE)

(72) Inventors: Markus JUNG, Schalksmuehl (DE); Gerald LIEB, Kernen (DE); Carsten TETTENBORN, Filderstadt (DE); Julian VOSSELER, Pfullingen (DE); Thomas SCHOEPF, Stuttgart (DE)

(21) Appl. No.: 15/770,015

(22) PCT Filed: Oct. 20, 2016
(86) PCT No.: PCT/EP2016/075256

§ 371 Date: Apr. 20, 2018

(30) Foreign Application Priority Data
Oct. 21, 2015 (DE) 10 2015 220 562.2

(51) Int. Cl. G06F 13/42; G05B 19/10; H04L 29/06

(52) U.S. Cl. CPC G06F 13/42; G05B 2219/25217; H04L 69/18; G05B 19/10

(57) ABSTRACT

The invention relates to a distribution module (1) and method for operating a distribution module. A distribution module comprises a housing (2) and a bus connection (3) and multiple device connections (4). Selection means (5), in particular a rotary selector switch, are provided, by means of which one of multiple communication protocols which are stored in a memory within the housing (2) can be manually selected from outside the housing (2). Alternatively, the selection means can also be configured as a DIP switch, membrane keyboard, touchscreen or key switch. The memory is preferably non-volatile. When a protocol is chosen and the controller parameterises the distribution module via said protocol, and a device then starts cyclic data exchange, the ID of said protocol is thereby also stored in a non-volatile manner. Electronic units such as computing units, memories, power supply and the suchlike are accommodated in the housing (2). In addition, the distribution module (1) comprises a bus connection (3), with which the distribution module (1) can be connected via a data line to a computing unit which is not represented. The distribution module (1) preferably comprises multiple device connections (4) which are similar or different to each other. The electro-mechanical or electronic adjustment option preferably relates to industrial fieldbus devices, such as I/O distribution modules, which work with standardised communication protocols (e.g. Profibus, PROFINET IO, Ethernet/IP, EtherCAT, SERCOSIII, Powerlink, CANopen, DeviceNet).

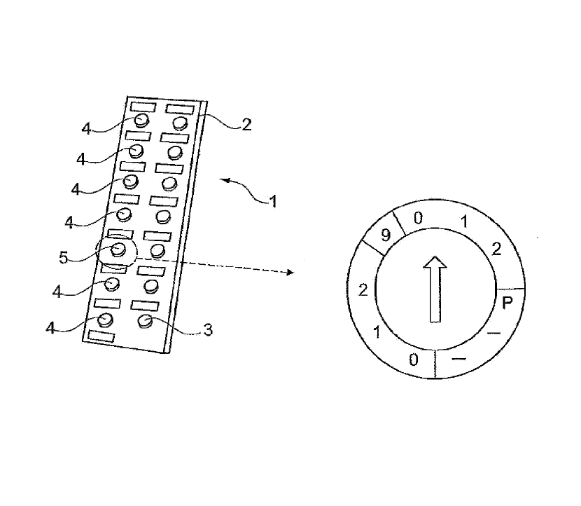

The invention relates to a distribution module and to a method of operating such a distribution module according to the features of the introductory clauses of the independent patent claims.

A distribution module having a housing, a bus connection, and a plurality of device connections is known from DE 102 27 422 [US 2004/0043671]. A central computer, for example a control device, a PLC device or the like, is connected via a data line to the central bus connection of such a distribution module and devices, such as sensors, actuators and the like, are connected to the device connections. Electronic devices that distribute the data received via the bus connection to the device connections and therefore to the devices connected to the latter and vice versa are provided inside the housing of the distribution module. In this embodiment, it is necessary for the data to be interchanged between the distribution module and the controller connected to the latter via a fixed predefined communication protocol. The protocol that is selected normally determines only the communication between the controller and the distribution module. If communication takes place between the distribution module and the connected devices, other protocols are usually involved, for example IO-Link or proprietary protocols or a digital in/out interface (IO-Link is in turn not a protocol that communicates with a controller).

However, this fixed specification of a communication protocol hinders the flexible use of distribution modules in those cases where the distribution module is intended to be used for a plurality of communication protocols. If for example the controller and the devices use a particular communication protocol in an application environment, a distribution module with precisely this communication protocol must also be used. However, this distribution module cannot be used in another application environment with another communication protocol, but rather it is necessary to have available a further distribution module that operates with the other communication protocol. This is disadvantageously very complicated with regard to the variety of possible communication protocols since it is necessary to have available different distribution modules each with different communication protocols. In addition, it is not necessarily possible for the user of a distribution module to discern when using the latter whether he has selected the distribution module with the correct communication protocol corresponding to the communication protocol that is used by the control device and the devices.

Therefore, the object of the invention is to provide a distribution module and a method of operating such a distribution module that avoids the above-described disadvantages described and with which the communication protocol being used is particularly clear.

This object is attained by the features of the two independent patent claims.

With regard to the distribution module per se, selection means are provided according to the invention and can be employed from outside the housing to manually select one of a plurality of communication protocols stored in a memory inside the housing. On the one hand, a plurality of communication protocols are stored in a memory inside the distribution module and are available for selection. This initially advantageously increases the flexibility when using such a distribution module since it can be used in different application environments that use different communication protocols. In addition, the communication protocol that is to be used and is intended to be retrieved from the memory can be easily selected in a targeted manner by a user via a selector, with the result that the communication protocol being used is clear as a result of this manual selection. In addition, operation of the distribution module can be started very quickly as a result of the communication protocol to be used being manually selected.

In one development of the invention, the memory that stores the plurality of communication protocols is nonvolatile. This has the important advantage that, in the event of interruptions or failures in the power supply, the stored data representing the communication protocols are retained in the memory and are immediately available again as soon as the power supply has been restored. However, if a protocol has been selected and the controller parameterizes the distribution module via this protocol and the device then starts the cyclical data interchange, the ID of this protocol is also stored in a nonvolatile manner. This protocol is then started when next starting the device without switch polling.

In one development of the invention, the selector is a rotary selector switch. This has the advantage that the communication protocol to be used can be selected very quickly and easily and clearly using such a rotary selector switch, in which case it is also simultaneously possible to clearly discern, in particular with suitable labeling, which communication protocol is currently being used via the position of the rotary selector switch.

As an alternative to a rotary selector switch, it is also conceivable for the selector to be in the form of a DIP switch, a membrane keyboard, a touchscreen or a key switch. DIP switches have the advantage that they can be changed very quickly. A membrane keyboard has the advantage that the communication protocol can be specified in an uncomplicated manner and, at the same time, there is mechanical protection from external influences acting on the distribution module, in particular spray, contaminants and the like, as a result of the keyboard being covered by a film. A touchscreen has the advantage of very simple operation, and a key switch makes it possible to not only select the desired communication protocol but to use a key to prevent the communication protocol that has been set once from being changed. This is used, in particular, to secure the operation of the distribution module.

The selector, that is to say the electromechanical or electronic setting option, is used to determine and start the preferably industrial communication protocol after switching on the supply voltage. The electromechanical or electronic setting option, called electrical setting option or protocol selector switch below, preferably relates in this case to industrial field bus devices, for example IO distribution modules that operate with all available standardized communication protocols (for example Profibus®, PROFINET IOC), Ethernet/IP™, EtherCAT®, SERCOSIII®, Powerlink®, CANopen®, DeviceNet™ and others). The industrial field bus devices mentioned here may have stored an arbitrary number of different communication protocols in the nonvolatile memory of the device.

The industrial communication protocol is selected and started according to the principle that has already been described. A communication protocol that has been started once can be changed only after a power cycle (off-on) by changing the protocol selector switch position, if the selected communication protocol has not yet previously carried out any cyclical data interchange with a communication master (such as a superordinate control device or the like). After the protocol selector switch position has been changed, a so-called “Factory Reset” for activating the new communication protocol may be necessary if the previously activated communication protocol on the field bus device has been changed once to the status “cyclical communication” by the communication master.

As already described, the electrical setting option may be, for example, rotary switches, DIP switches, membrane keyboards, a touchscreen, key switches or the like if they are advantageously part of the industrial field bus device anyway and are normally used to set the field bus address or IP address.

In order to further describe the distribution module according to the invention and its operation, reference is made below to the drawing.

The drawing illustrates, in principle, a distribution module 1 having a housing 2. Electronic devices such as computing units, a memory, a power supply and the like, are accommodated in the housing 2 but are not illustrated in detail. The distribution module 1 also has a bus connection 3 that can be used to connect the distribution module 1 to a computing unit (not illustrated) via a data line. The distribution module 1 also has a device connection 4, preferably a plurality of them that are identical to one another or differ from one another. Devices, such as actuators, sensors, computers, further distribution modules and the like that are not illustrated are connected to these device connections 4 that are in the form of M8 or M12 screw connectors, for example. The electronic devices in the housing 2 make it possible to interchange data and to distribute data between the computing unit that is connected to the bus connection 3 and the devices that are connected to the device connections 4. This data is interchanged using permanently predefined, preferably standardized or else proprietary communication protocols. This means that, in order to move data between the individual elements, the communication protocol of the distribution module must use the communication protocol of the computing unit. In order to be able to react to different communication protocols of the computing unit and of the connected devices and to be able to establish identity of the communication protocols, a selector, in particular a rotary selector switch 5, are provided in the housing 2 of the distribution module 1. These selectors, in particular the rotary selector switches 5, are accessible from outside the housing 2 of the distribution module 1, with the result that the communication protocol to be set is called from the memory inside the housing 2 of the distribution module 1 by changing the position of the respective selector, in particular the rotary selector switch 5, and the distribution module 1 is operated using this communication protocol after it has been selected.

There are preferably two power connections beside one another (the power connections are internally looped through in the device) and also two bus connections. The two bus connections are looped through in the case of field buses or are forwarded via an internal switch in the case of Ethernet protocols. However, one power connection and one bus connection would also suffice.

### LIST OF REFERENCE SYMBOLS

1. Distribution module
2. Housing
3. Bus connection
4. Device connection
5. Rotary selector switch

1. A distribution module comprising:
a housing;
a bus connection on the housing;
a plurality of device connections on the housing;
a memory inside the housing and holding a plurality of communication protocols; and
a selector on the housing and operable from outside the housing to manually select one of the communication protocols stored in the memory inside the housing.

2. The distribution module according to claim 1, wherein the memory is nonvolatile.

3. The distribution module according to claim 1, wherein the selector is a rotary selector switch.

4. The distribution module according to claim 1, wherein the selector is a DIP switch, a membrane keyboard, a touchscreen or a key switch.

5. A method of operating a distribution module having a housing, a bus connection on the housing, a memory inside the housing, and a plurality of device connections on the housing, the method comprising the step of:
storing a plurality of communication protocols in the memory; and
manually operating a selector from outside the housing to select one of the communication protocols stored in the memory inside the housing.

6. The method according to claim 5, further comprising the step of:
determining and starting the communication protocol after switching on a supply voltage for the memory.

7. The method according to claim 5, further comprising the step of:
only changing a one of the protocols that has been started once after a power cycle by changing the setting of the selector, if the selected communication protocol has not yet previously carried out any cyclical data interchange with a communication master.
